(19) United States
(12) Patent Application Publication
(10) Pub. No.: US 2010/0295864 A1
(43) Pub. Date: Nov. 25, 2010

(54) Methods and Systems for Setting a Backlight Level

(76) Inventors: Louis J. Kerofsky, Camas, WA (US); Jiading Gai, South Bend, IN (US)

Correspondence Address: Kristine Elizabeth Matthews, 19302 SE 31st Drive, Camas, WA, 98607, US

(21) Appl. No.: 12/470,364

(22) Filed: May 21, 2009

(51) Int. Cl. G09G 5/02; G09G 3/36

(52) U.S. Cl. 345/589; 345/102

(57) ABSTRACT

Aspects of the present invention are related to systems and methods for selecting backlight array driving values.

### FIELD OF THE INVENTION

Embodiments of the present invention comprise methods and systems for selecting a display source-light illumination level.

### BACKGROUND

Some display systems may have backlight arrays with individual elements that can be individually addressed and modulated. Methods and systems for reducing power consumption while maintaining image quality in these display systems may be desirable.

### SUMMARY

Some embodiments of the present invention comprise methods and systems for selecting a display source-light, also considered a backlight, illumination level.

In some embodiments of the present invention, a backlight power level may be set by minimizing a distortion function between a block of image data associated with a backlight segment and a power-level-dependent version of the block of image data. The distortion function may include a power level penalty term. The distortion function may weight the contribution of the image distortion at a pixel in a block based on the distance of the pixel from the illumination source. In some embodiments of the present invention, a block may be centered with respect to the location of the associated illumination source.

In some embodiments of the present invention, a first block of image data associated with a first backlight segment may overlap a second block of image data associated with a second backlight segment.

In some embodiments of the present invention, determination of a power level setting may comprise efficient optimization combining parabolic interpolation and a golden section.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a chart showing exemplary embodiments of the present invention comprising selection of backlight driving values;

FIG. 2 is a chart showing exemplary embodiments of the present invention comprising selection of backlight driving values;

FIG. 3 is a chart showing exemplary embodiments of the present invention comprising selection of a backlight driving value for each segment in an array of illumination sources;

FIG. 4 is a diagram showing various relationships between processed images and display models;

FIG. 5A is a picture of an exemplary distortion plot, wherein the distortion cost function does not comprise a bias term;

FIG. 5B is a picture of an exemplary distortion plot, wherein the distortion cost function comprises a bias term; and

FIG. 6 is a chart showing exemplary embodiments of the present invention comprising efficient distortion calculation using a block histogram.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Backlight modulation is a technique for reducing a liquid crystal display (LCD) backlight, also considered an illumination source, and compensating for the backlight reduction by modifying the data sent to the LCD. The quality of the displayed image may be degraded by the backlight-level selection algorithm. Methods and systems for backlight-level selection that reduce power while preserving image quality, for example, highlights, texture details, color and other image features, may be desirable.

Some embodiments of the present invention relate to methods and systems disclosed in U.S. patent application Ser. No. 11/465,436, entitled “Systems and Methods for Selecting a Display Source Light Illumination Level,” filed on Aug. 17, 2006, which is hereby incorporated by reference herein in its entirety.

Some embodiments of the present invention relate to methods and systems disclosed in U.S. patent application Ser. No. 11/843,529, entitled “Methods and Systems for Motion Adaptive Backlight Driving for LCD Displays with Area Adaptive Backlight,” filed on Aug. 22, 2007, which is hereby incorporated by reference herein in its entirety.

Some embodiments of the present invention comprise methods and systems for backlight-level selection in a 2-dimensional (2D) area-active light emitting diode (LED) backlight.

Some embodiments of the present invention comprise an LCD display comprising two modulation channels: a programmable array of backlight LEDs and a programmable front LCD panel. Contrast improvement that can be achieved with backlight modulation may be determined by the number of addressable LED segments and the spatial extent of the optical profile of these segments. Given a fixed number of LEDs, with fixed optical profiles, an adaptive backlight-selection algorithm that receives a high resolution image as input and calculates an optimal low resolution ideal backlight image, also considered an LED driving signal, may be desirable.

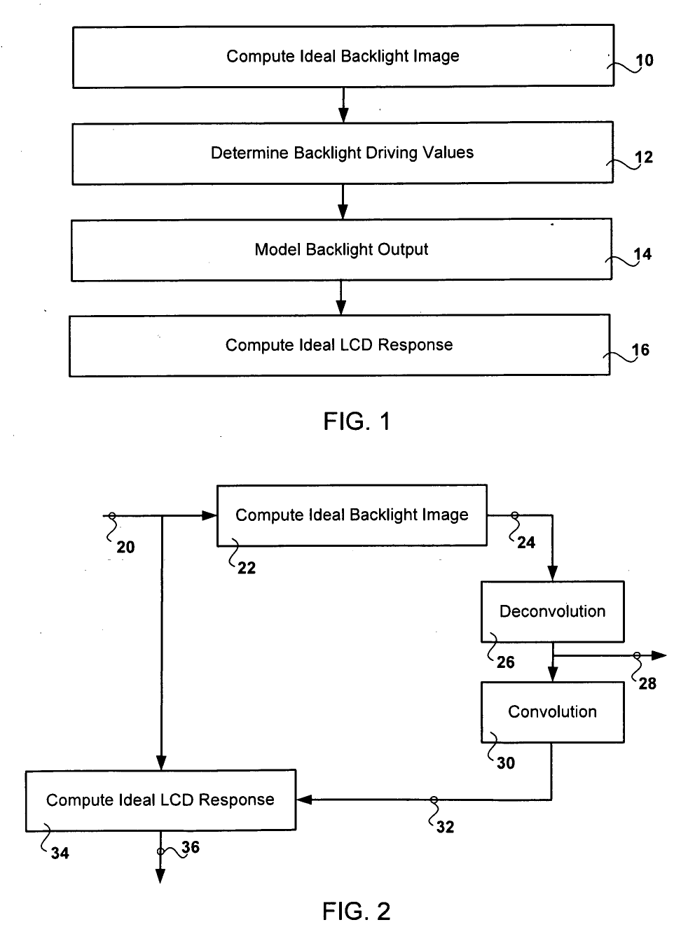

Some embodiments of the present invention may be described in relation to FIG. 1. An ideal backlight image, also considered an LED driving signal, may be computed 10 for an input image, and backlight driving values may be determined 12. The backlight output may be modeled 14 using the optical profiles of the LED segments, and an ideal LCD response may be computed 16. Some embodiments of the present invention comprise distortion-minimization based methods and systems for selecting 10 an ideal backlight image.

In some embodiments of the present invention described in relation to FIG. 2, an input image 20 may be used to compute 22 an ideal backlight image 24 and to compute 34 an ideal LCD response 36, also considered a compensating LCD image, which may be sent to the LCD panel. The ideal backlight image 24 may be deconvolved 26 to determine the backlight driving values 28, which may be sent to the LED array. The backlight driving values 28 may be convolved 30 with the optical profiles of the LED segments to model the backlight output 32, which may be used in conjunction with the input image 20 to compute 34 the ideal LCD response 36. The ideal LCD response 36 may be computed 34 for a pixel by dividing the ideal luminance of the pixel by the backlight output for the pixel.

Some anti-aliasing based backlight-selection methods divide an input image into non-overlapping blocks and determine the local average among each block. These methods, by taking the local average, roughly determine the least energy that is adequate for displaying the input image average. However, this may result in possible loss of highlight and texture details due to the insensitivity of these methods to the local maximum.

Local-maximum based backlight selection methods divide an input image into non-overlapping blocks and determine the local maximum of each block. The backlight level for a block is completely governed by the local maximum with the block. These methods determine the least amount of energy that is adequate for preserving all the details in the input image.

Some embodiments of the present invention may balance using the local average and the local maximum. Backlight selection according to embodiments of the present invention may be varied smoothly from using the least amount of power, which may correspond to greater degradation in image quality, and using the most amount of power, which may correspond to the maximum image quality preservation. Additionally, backlight selection according to embodiments of the present invention may allow various displayed-image degradation issues that previously had to be addressed separately to be taken into account together within one cost function.

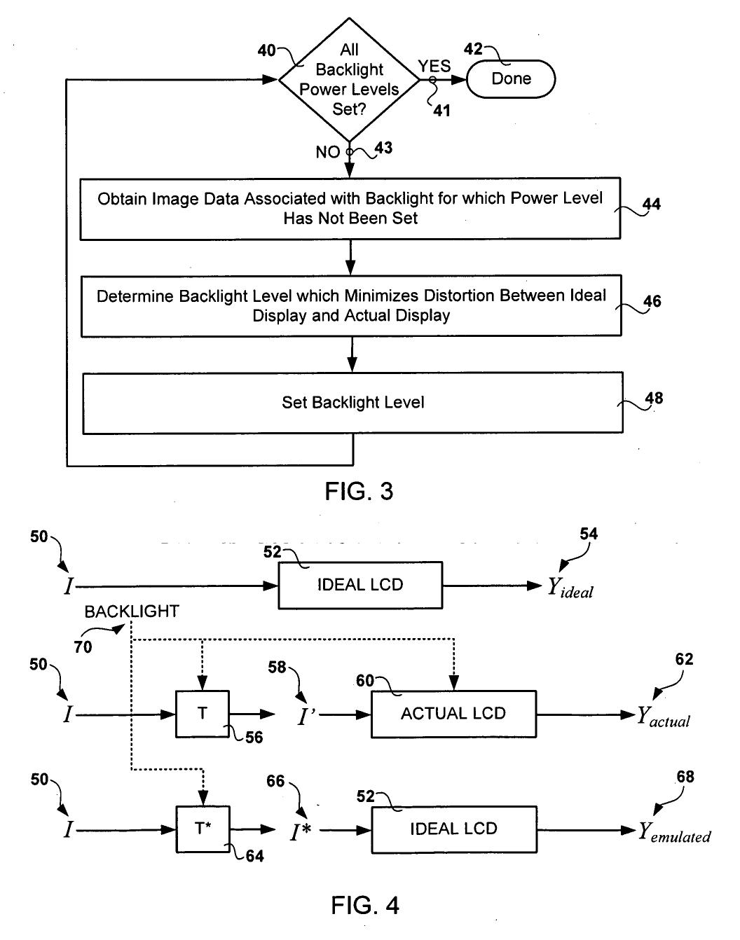

In some embodiments of the present invention, an input image may be divided into overlapping blocks wherein each block is associated with an illumination source in an array of illumination sources. In some embodiments, an illumination source may comprise an LED. An image block may be processed to determine a power-level setting, also considered a backlight level, for the illumination source associated with the image block. In some embodiments of the present invention described in relation to FIG. 3, the backlight level may be determined by minimization of a distortion associated with the block.

In some embodiments of the present invention described in relation to FIG. 3, a determination of whether or not all backlight power levels have been set may be made 40. If all backlight power levels have been set 41, then the backlight power level setting process may terminate 42. If there remains a backlight for which the power level has not been set 43, then image data associated with the backlight may be obtained 44. In some embodiments, the image data may be associated with a region of the display centered at the backlight location. In some embodiments of the present invention, a first region associated with a first backlight may overlap a second region associated with a second backlight. In these embodiments, the image data may be divided into overlapping blocks of image data, wherein each block may be associated with a backlight. A backlight power level that minimizes the distortion between an ideal display and an actual display may be determined 46. The backlight level may be set 48 to the determined power level, and a determination of whether or not all backlight power levels have been set may be made 40.

Some embodiments of the present invention may be understood in relation to a hypothetical reference display and an actual LCD. Both the hypothetical reference display and the LCD may be described using a GOG (gain, offset, gamma) model. The hypothetical reference display may be modeled as an ideal display with a zero black level and a maximum output, which may be denoted W. The actual display may be modeled as having the same maximum output, W, at full backlight and a black level, which may be denoted B, at full backlight. A contrast ratio, which may be denoted CR, may be determined according to:

$$C R = \frac{W}{B} ,$$

wherein the contrast ratio is infinite when the black level is zero.

Denoting a maximum image code value by cvₘₐₓ, the hypothetical reference display output for an image code value, which may be denoted cv, may be expressed mathematically as:

$${Y}_{ideal} ( c v ) = {W ( \frac{c v}{c {v}_{max}} )}^{γ} ,$$

where γ denotes the display gamma.

The actual LCD output for an image code value and a backlight level, which may be denoted P, may be modeled according to:

$${Y}_{actual} ( P , c v ) = {P ( Gain \cdot \frac{c v}{c {v}_{max}} + Offset )}^{γ} , \\ where$$

$$Offset = {B}^{\frac{1}{γ}} and Gain = {W}^{\frac{1}{γ}} - {B}^{\frac{1}{γ}} ,$$

and the black level and maximum output may depend on the backlight level according to:

B(P)=P·B and W(P)=P·W,

where the contrast ratio,

$$C R = \frac{W}{B} ,$$

may be independent of the backlight level.

Embodiments of the present invention may be understood in relation to FIG. 4 which depicts various modified images that may be created and may be used in embodiments of the present invention. An original image 50, which may be denoted I, may be used as input in creating each of these exemplary modified images. In some embodiments, the original, input image, I 50, may be processed 52 to yield an ideal output, Y_{ideal} 54. The ideal image processor 52 associated with a reference, also considered ideal, display may assume that the ideal display has a zero black level. The ideal output, Y_{deal} 54, may represent the original image, I 50, as seen on a reference display. In some embodiments, assuming a backlight level 70, P, is given, the distortion caused by representing the image with this backlight level on the actual LCD may be computed.

In some embodiments, a brightness preservation method or system 56 may be used to generate an image, which may be denoted I′ 58, from the image I 50. The image I′ 58 may then be sent to the actual LCD processor 60 along with a selected backlight level 70. The resulting output may be labeled Y_{actual} 62.

The reference display model may emulate the output of the actual display by using an input image I* 66.

The output of the actual LCD 60 may be the result of passing the original image I 50 through a luminance matching tone scale function 56 to get the image I′ 58. Depending on the backlight level 70, this may not exactly reproduce the reference output. However, the actual display output can be emulated on the reference display 52. The image I* 66 may denote the image data sent to the reference display 52 to emulate the actual display output, thereby creating Y_{emulated} 68.

The output of the ideal LCD strictly contains the output of the actual display. The relative position of the actual LCD output within the ideal display output is a function of the contrast ratio and backlight level. At a given backlight level P, the output of the actual LCD spans a range from P·B to P·W. The achievable output of the actual LCD display may be emulated on the ideal LCD by clipping the ideal display output to this range. The image I* 66 may be produced by clipping the image I 50 to the range determined by clipping points, which may be denoted x_{low}(P) and x_{high}(P), defined according to:

$${x}_{low} ( P ) = c {{v}_{max} ( \frac{P \cdot B}{W} )}^{\frac{1}{γ}} and {x}_{high} ( P ) = c {{v}_{max} ( P )}^{\frac{1}{γ}} ,$$

respectively, where the clipping operation may be expressed:

$${I}^{*} ( r , c ; c v , P ) = \{ \begin{matrix}{x}_{low} ( P ) & c v \leq {x}_{low} ( P ) \\ c v & {x}_{low} ( P ) < c v < {x}_{high} ( P ) \\ {x}_{high} ( P ) & {x}_{high} ( P ) \leq c v ,\end{matrix}$$

where I*(r, c; cv,P) denotes the value of I* 66 at a pixel located in the image at row r and column c, and cv is the code value in I 50 at the corresponding pixel location, cv=I(r,c).

A distortion measure, denoted D, may be defined between the original and emulated images according to:

D(Y_{ideal},Y_{emulated},P)=D(I,I*(P)),

where the distortion measure may be calculated over associated portions of the original and emulated images.

For an image block, which may be denoted I_{block}, in the original image I and an corresponding image block, which may be denoted I*_{block}, in the emulated image I*, a distortion measure associated with an illumination level P may be determined by calculating a distance measure between the values of corresponding pixels in the image blocks across the color channels. In some embodiments, a mean-square-error between the values of corresponding pixels in the image blocks across the color channels may be determined according to:

$$\begin{matrix}\begin{matrix}D ( {I}_{block} , {I}_{block}^{*} , P ) = {\sum }_{( r , c ) ∈ block} d ( I ( r , c ) , {I}^{*} ( r , c ; c v , P ) ) \\ = {\sum }_{( r , c ) ∈ block} {[ I ( r , c ) - {I}^{*} ( r , c ; c v , P ) ]}^{2} \\ = {\sum }_{( r , c ) ∈ block \vert I ( r , c ) < {x}_{low} ( P )} {[ I ( r , c ) - {I}^{*} ( r , c ; c v , P ) ]}^{2} + \\ {\sum }_{( r , c ) ∈ block \vert I ( r , c ) > {x}_{high} ( P )} {[ I ( r , c ) - {I}^{*} ( r , c ; c v , P ) ]}^{2} ,\end{matrix} & \\ where c v = I ( r , c ) and d ( \text{·,·} ) denotes a distance measure . & \end{matrix}$$

Some embodiments of the present invention may comprise determination of an optimal illumination level P for which the distortion is minimized. However, if the distortion function is non-convex, then the determined P may not be the desired value. In some embodiments of the present invention, a penalty term may be added to the distortion function. The penalty term may make the distortion function more convex. The penalty term may make the distortion function have a unique minimum distortion solution. In some embodiments of the present invention, the penalty term may penalize solutions with high backlight levels. An exemplary penalty term may be W₁·P, where W₁ may be a weighting factor. In some embodiments of the present invention, W₁ may be set to 100.

An overall distortion cost function comprising a penalty term for high energy cost may be given according to:

$$D ( {I}_{block} , {I}_{block}^{*} , P ) = {\sum }_{\begin{matrix}( r , c ) ∈ block \\ \vert I ( r , c ) < {x}_{low} ( P )\end{matrix}} {[ I ( r , c ) - {I}^{*} ( r , c ; c v , P ) ]}^{2} + {\sum }_{\begin{matrix}( r , c ) ∈ block \\ \vert I ( r , c ) < {x}_{high} ( P )\end{matrix}}^{ } {[ I ( r , c ) - {I}^{*} ( r , c ; c v , P ) ]}^{2} + {W}_{1} \cdot P .$$

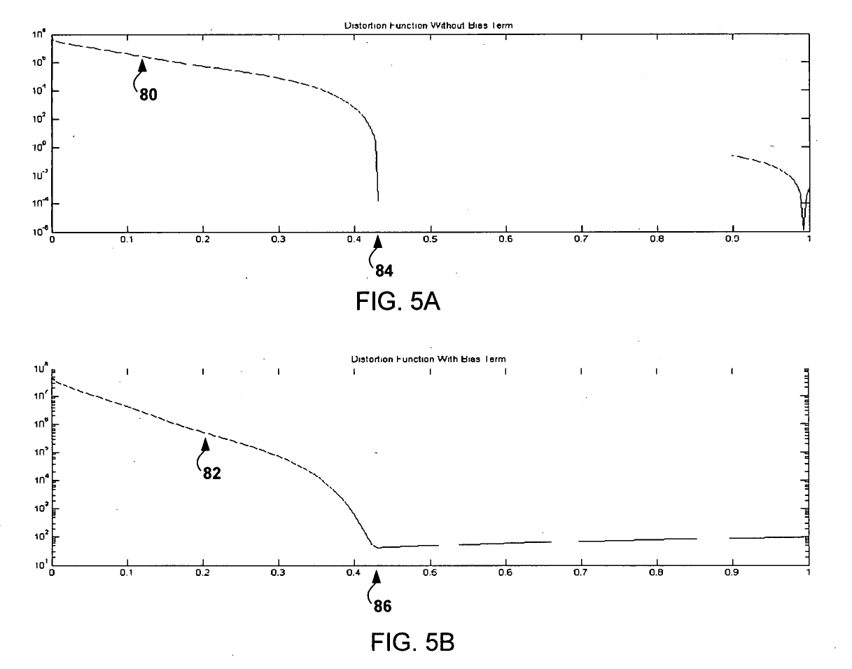

FIG. 5A depicts exemplary distortion data 80 without a penalty term, also considered a bias term, as a function of backlight level, and FIG. 5B depicts exemplary distortion data 82 with a penalty term as a function of backlight level. As is readily seen by examination of these plots, the distortion function 80 without the penalty term is not well-behaved. It is not even differentiable, which may render the optimization problem difficult to solve. However, the distortion function with the penalty term 82, on the other hand, is a well-behaved, convex function with a non-ambiguous minimum point. Note that the desired backlight level 84, 86 P is virtually the same in both plots. This shows that adding the penalty term may not change the optimal solution, may render the optimization process much easier to perform.

An HDTV (High Definition Television), typically 1920 pixels by 1080 pixels, may comprise a much lower resolution backlight layer, for example, as low as 8 by 8 LED segments. The optical profiles of the LEDs may have a long tail to achieve brightness uniformity. One major drawback of some state-of-the-art backlight selection algorithms is that the backlight driving signal does not follow the position of a bright object, resulting in breathing effects. Such methods may ignore the solution gap between the backlight and the LCD panel and the computed backlight may vary with the position of a bright object relative only to the segment grid. This may result in annoying and noticeable appearance of the backlight structure in the displayed frames.

To alleviate breathing effects, some embodiments of the present invention may divide the input image into overlapping blocks as opposed to non-overlapping blocks used by other backlight selection algorithms. In some embodiments of the present invention, the contribution of a pixel to the distortion measure associated with a block may be weighted based on the distance of the pixel from the center of the block. In some embodiments, the weighting may be accomplished using a Parzen window in each of the coordinate directions according to:

$$w ( n ) = \{ \begin{matrix}1.0 - 6 {( \frac{n}{N / 2} )}^{2} ( 1.0 - \frac{\vert n \vert}{N / 2} ) , & 0 \leq \vert n \vert \leq \frac{N}{4} \\ 2 {( 1.0 - \frac{\vert n \vert}{N / 2} )}^{3} , & \frac{N}{4} \leq \vert n \vert \leq \frac{N}{2} ,\end{matrix}$$

where L=N+1 is the size of the window and n is the distance of the pixel from the center of the window.

In some embodiments of the present invention, a block histogram, which may be denoted h(cv), may be computed for a block. In these embodiments, the calculation of the distortion function may be separated into two parts: terms that are independent of the backlight level P and terms that are dependent on P. The distortion may be calculated using the block histogram according to:

$$D ( {I}_{block} , {I}_{block}^{*} , P ) = {\sum }_{c v < {x}_{low} ( P )} {h ( c v ) [ c v - {x}_{low} ( P ) ]}^{2} + {\sum }_{c v > {x}_{high} ( P )} {h ( c v ) [ c v - {x}_{high} ( P ) ]}^{2} + {W}_{1} \cdot P ,$$

where h(cv) is the number of pixels in the block with code value cv. The histogram h(cv) may be used, without re-calculation, in each distortion calculation since h (cv) does not depend on P.

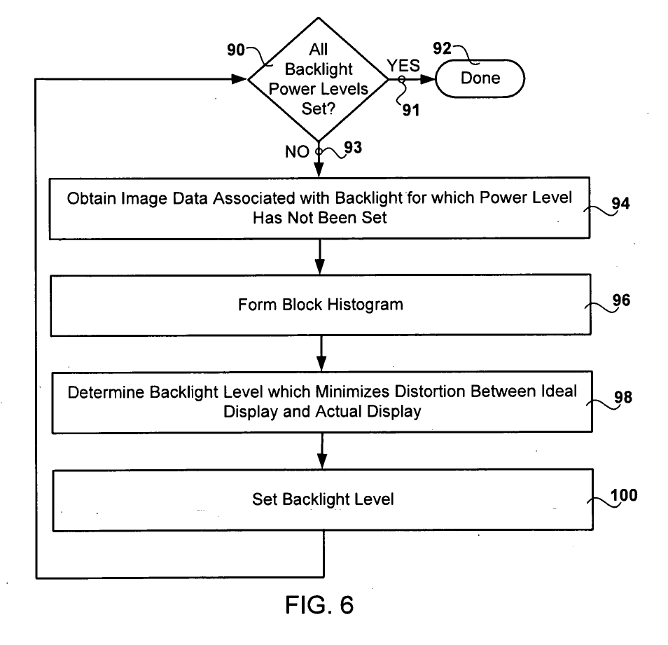

In some embodiments of the present invention described in relation to FIG. 6, the computation of the block histogram may be done prior to optimization. In these embodiments, a determination of whether or not all backlight power levels have been set may be made 90. If all backlight power levels have been set 91, then the backlight power level setting process may terminate 92. If there remains a backlight for which the power level has not been set 93, then image data associated with the backlight may be obtained 94. In some embodiments, the image data may be associated with a region of the display centered at the backlight location. In some embodiments of the present invention, a first region associated with a first backlight may overlap a second region associated with a second backlight. In these embodiments, the image data may be divided into overlapping blocks of image data, wherein each block may be associated with a backlight. A block histogram may be formed 96 for the block, and a backlight power level that minimizes the distortion between an ideal display and an actual display may be determined 98. The backlight level may be set 100 to the determined power level, and a determination of whether or not all backlight power levels have been set may be made 90.

In some embodiments of the present invention comprising weighted contribution to the distortion, the block histogram may be formed by accumulating a weighted count associated with a pixel based on the distance of the pixel from the center of the window.

In some embodiments of the present invention, determination 46, 98 of the backlight level for which the distortion is minimized may be accomplished by exhaustive computation of distortion measures associated with each possible backlight level setting.

Alternative embodiments of the present invention may use inverse quadratic interpolation in combination with a bisection method. A golden section method may repeatedly divide an interval according to the golden ratio and then may select the subinterval in which a minimum exists. The golden second method converges linearly, which is quite slow. But, on the positive side, the golden section method is guaranteed to converge if the minimum solution is well bracketed. Inverse quadratic interpolation uses quadratic interpolation to approximate a cost function. The algorithm converges super linearly. However, performance is often quite poor if the cost function is not well-behaved or if the initial position is not very close to the actual minimum. Embodiments of the present invention may combine these two optimization methods. When the parabolic interpolation implies a movement that is less than half the movement of the step before last, then the step may be used. Otherwise, golden section may be used to compute the next step.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for selecting a display illumination-source power level, said method comprising:
a) in a display system, receiving a first plurality of pixel values associated with an image;
b) determining a first image block associated with said image and a first illumination source in said display system, said first image block comprising a second plurality of pixel values from said first plurality of pixel values;
c) determining a second image block associated with said image and a second illumination source in said display system, wherein said first image block and said second image block overlap; and
d) selecting a final power level setting for said first illumination source, wherein said final power level setting minimizes a distortion measure between said second plurality of pixel values and a power-level-dependent clipped version of said second plurality of pixel values.

2. The method as described in claim 1 further comprising calculating a block histogram associated with said first image block.

3. The method as described in claim 1, wherein said distortion measure is a weighted distortion measure.

4. The method as described in claim 3, wherein said weighting is based on a Parzen window.

5. The method as described in claim 1, wherein:
a) said first illumination source comprises a first LED in an LED array in said display system; and
b) said second illumination source comprises a second LED in said LED array in said display system.

6. The method as described in claim 1, wherein said selecting comprises:
a) calculating a first value of said distortion measure at a first power level;
b) calculating a second value of said distortion measure at a second power level;
c) using parabolic interpolation, determining a third power level based on said first value of said distortion measure and said second value of said distortion measure;
d) using said third power level in said selecting when said first power level, said second power level and said third power level meet a first criterion; and
e) when said first power level, said second power level and said third power level do not meet said first criterion:
i) determining a fourth power level using a golden section; and
ii) using said fourth power level, said first power level and said second power level in said selecting.

7. The method as described in claim 6, further comprising calculating a block histogram associated with said first image block.

8. The method as described in claim 1, wherein said display system comprises an LCD.

9. The method as described in claim 1, wherein said distortion measure comprises a power-level penalty term.

10. The method as described in claim 1, wherein said distortion measure comprises a mean-squared error between said second plurality of pixel values and said power-level-dependent clipped version of said second plurality of pixel values.

11. The method as described in claim 10, wherein said mean-squared error is a weighted mean-squared error.

12. The method as described in claim 11, wherein said weighting is based on a Parzen window.

13. The method as described in claim 1, wherein:
a) a power-level-dependent clipped version of a first pixel value in said second plurality of pixel values comprises:
i) said first pixel value when said first pixel value is between a lower threshold value and a higher threshold value;
ii) said lower threshold value when said first pixel value is less than or equal to said lower threshold value; and
iii) said higher threshold value when said first pixel value is greater than or equal to said higher threshold value; and
b) wherein:
i) said lower threshold value is based on a first power level; and
ii) said higher threshold value is based on said first power level.

14. A system for selecting a display illumination-source power level, said system comprising:
a) an image receiver for receiving a first plurality of pixel values associated with an image;
b) a block determiner for:
i) determining a first image block associated with said image and a first illumination source in said display system, said first image block comprising a second plurality of pixel values from said first plurality of pixel values; and
ii) determining a second image block associated with said image and a second illumination source in said display system, wherein said first image block and said second image block overlap; and
c) a power-level selector for selecting a final power level setting for said first illumination source, wherein said final power level setting minimizes a distortion measure between said second plurality of pixel values and a power-level-dependent clipped version of said second plurality of pixel values.

15. The system as described in claim 14 further comprising a histogram calculator for calculating a histogram associated with said first image block.

16. The system as described in claim 14, wherein:
a) said first illumination source comprises a first LED in an LED array; and
b) said second illumination source comprises a second LED in said LED array.

17. The system as described in claim 14, wherein said power-level selector comprises:
a) a distortion-measure calculator for:
i) calculating a first value of said distortion measure at a first power level; and
ii) calculating a second value of said distortion measure at a second power level;
b) a parabolic interpolator for determining a third power level based on said first value of said distortion measure and said second value of said distortion measure;
c) an update selector for:
i) selecting said third power level for use in said selecting when said first power level, said second power level and said third power level meet a first criterion; and
ii) initiating determination of a fourth power level using a golden section when said first power level, said second power level and said third power level do not meet said first criterion; and
iii) using said fourth power level, said first power level and said second power level in said selecting; and
d) a golden section determiner for determining said fourth power level using said golden section when said first power level, said second power level and said third power level do not meet said first criterion.

18. The system as described in claim 14 further comprising an LCD.

19. The system as described in claim 14, wherein said distortion measure comprises a power-level penalty term.

20. The system as described in claim 14, wherein said distortion measure comprises a mean-squared error between said second plurality of pixel values and said power-level-dependent clipped version of said second plurality of pixel values.

21. The system as described in claim 20, wherein said mean-squared error is a weighted mean-squared error.

22. The system as described in claim 21, wherein said weighting is based on a Parzen window.

23. An image display system comprising:
a) a display;
b) an plurality of illumination sources;
c) an image receiver for receiving an image for display on said display; and
d) an illumination-source power level determiner for determining a power level setting for a first illumination source in said plurality of illumination sources, wherein said illumination-source power level determiner comprises:
i) an image-block receiver for receiving a portion of said image; and
ii) a distortion calculator for calculating a distortion measure associated with said portion of said image and a power level, wherein said distortion measure comprises:
(1) a power-level penalty term; and
(2) a mean-squared-error term between said portion of said image and a power-level-dependent clipped version of said portion of said image.
